(19) United States
(12) Patent Application Publication
(10) Pub. No.: US 2026/0348776 A1
(43) Pub. Date: Nov. 5, 2026

(54) SENSOR MODULE FOR PRESSURE MEASUREMENT AND VIBRATION FEEDBACK AND PRESSURE MEASUREMENT METHOD THEREFOR

(71) Applicant: SHENZHEN SIPO TECHNOLOGY DEVELOPMENT CO., LTD., Shenzhen (CN)

(72) Inventor: Guanhua CHEN, Shenzhen (CN)

(21) Appl. No.: 19/124,640

(22) PCT Filed: Oct. 20, 2023
(86) PCT No.: PCT/CN2023/125532

§ 371 Date: Jun. 25, 2025

(30) Foreign Application Priority Data
Oct. 27, 2022 (CN) 202211327912.0

(51) Int. Cl. G01L 1/16

(52) U.S. Cl. CPC G01L 1/16

(57) ABSTRACT

A sensor module for pressure measurement and vibration feedback, comprising a piezoelectric ceramic piece (1) and an FPC board (2), wherein four piezoresistive inks (4) are arranged on the FPC board (2) to form a resistor, the piezoelectric ceramic piece (1) is arranged at a gap of the FPC board (2), and the whole module is a thin structure. According to the module structure, a pressure test of a pressure sensor and high-voltage driving of the piezoelectric ceramic piece (1) are isolated, so that a low-voltage part of the pressure sensor and a high-voltage part driven by a piezoelectric ceramic are combined on one FPC board (2). Driving feedback of the piezoelectric ceramic piece (1) is achieved by means of adding a voltage of 100 V to 300 V to driving voltage ports VH1 and VH2 of the piezoelectric ceramic piece (1). Further provided is a pressure measurement method for the sensor module. When the piezoelectric ceramic piece (1) is stressed and deformed, two piezoresistive inks (4) are deformed to increase the size of the resistor. The magnitude of the pressure borne by the piezoelectric ceramic piece (1) is measured by means of calculating a voltage difference and then by means of a linear equation.

### CROSS-REFERENCE TO RELATED APPLICATION(S)

This application is a national phase entry of PCT/CN2023/125532, filed Oct. 20, 2023, which claims priority to CN 202211327912.0, filed on Oct. 27, 2022, the entire contents of which are fully incorporated herein by reference.

### TECHNICAL FIELD

The present disclosure relates to the field of haptic feedback technology, specifically to a sensor module for pressure measurement and vibration feedback and its pressure measurement method.

### BACKGROUND ART

Haptic feedback technology is a currently popular technology, and pressure measurement technology and vibration feedback technology are core components of this haptic feedback technology.

I. Pressure measurement technologies in haptic feedback applications are divided into two main categories:

The first category utilizes the piezoelectric effect of piezoelectric ceramics: mechanical deformation generates alternating voltage, and the magnitude of the deformation is determined by measuring the magnitude of this voltage.

The second category utilizes strain gauges or piezoresistive inks to form a Wheatstone bridge. Deformation changes the resistance value of one or more resistors, and the magnitude of the deformation is calculated by measuring the tiny voltage change of the Wheatstone bridge.

The first category has obvious drawbacks: the piezoelectric effect is only significant when the deformation speed is fast; when the pressure remains constant, the output voltage of the piezoelectric ceramic is zero. Therefore, it is impossible to accurately measure situations where pressure changes are small or pressure cannot be maintained well.

The second category can overcome the drawbacks of the first category: the second category can measure small pressure changes and situations where pressure remains constant. For example, electronic scales commonly used in daily life are typical applications of this type.

II. Vibration feedback technologies are also divided into two main categories:

The first category, linear motors: utilizes the electromagnetic effect, driving magnetic materials such as iron blocks to rapidly start and stop along the Z-axis, X-axis, or Y-axis of the linear motor, generating specific vibrations to achieve vibration feedback.

The second category, piezoelectric ceramics: applies a higher voltage, such as 60 to 300V, to the two poles of the piezoelectric ceramic to generate mechanical energy, thereby achieving vibration feedback.

Linear motors require a large volume to generate sufficiently large mechanical vibrations, and compared to piezoelectric ceramics, they require longer operating times and vibration cycles, and relatively more electrical energy. Therefore, products driven by linear motors are difficult to make thin and light.

In addition, piezoelectric ceramics have advantages in terms of being thin and light in volume, and are also more power-efficient. However, piezoelectric ceramics require higher voltages, thus requiring dedicated circuits for management.

### SUMMARY

The technical problem to be solved by the present disclosure is to provide a sensor module for pressure measurement and vibration feedback and its pressure measurement method. The purpose of designing this sensor module is to measure the pressure change or absence of pressure on a piezoelectric ceramic sheet to achieve vibration feedback.

To solve the above technical problem, the present disclosure achieves this through the following solution: the sensor module for pressure measurement and vibration feedback of the present disclosure may include:
A piezoelectric ceramic sheet, whose front surface is covered with a ring-shaped copper surface serving as an electrode and an electrode metal contact located in the inner circle of the ring-shaped copper surface, wherein the ring-shaped copper surface is adhered with a first conductive double-sided tape, and the electrode metal contact is adhered with a second conductive double-sided tape;
An FPC board, having a connected hollow part and a circular part, wherein the hollow part and the circular part form a structure with a gap after being bent at the connection, the piezoelectric ceramic sheet is disposed within this gap, the front surface of the circular part is adhered and fixed to the back surface of the piezoelectric ceramic sheet, and the hollow part and the front surface of the piezoelectric ceramic sheet are adhered and fixed by the first conductive double-sided tape and the second conductive double-sided tape;
Four piezoresistive inks are printed on the front surface of the circular part, these four piezoresistive inks can form resistors and are distributed on the midlines of each side of a rectangle, and these four piezoresistive inks form a Wheatstone bridge circuit;
The hollow part, on the side adhered and fixed to the piezoelectric ceramic sheet, is provided with a circuit connected to the four piezoresistive inks, and this circuit is provided with a first contact electrode and a second contact electrode, the first conductive double-sided tape is adhered to the first contact electrode to form an electrically conductive structure, and the second conductive double-sided tape is adhered to the second contact electrode to form an electrically conductive structure;
The back surface of the piezoelectric ceramic sheet is adhered with buffer sheets, these multiple buffer sheets are divided into two equal parts, these two parts of buffer sheets are symmetrically disposed at the edge of the piezoelectric ceramic sheet and are respectively close to two opposing piezoresistive inks, and far from the other two piezoresistive inks.

Optionally, the buffer sheet may be a curved and double-sided adhesive rubber thin sheet or a curved and double-sided adhesive silicone thin sheet.

Optionally, the four piezoresistive inks may be, in clockwise direction, resistor R1, resistor R3, resistor R4, and resistor R2, wherein resistor R1 and resistor R4 are respectively close to the two parts of the buffer sheets.

More optionally, one end of the hollow part may be provided with an FPC connector, this FPC connector is provided with six electrical contacts, these six electrical contacts are respectively a VS electrical contact, an S1 electrical contact, an S2 electrical contact, a GND electrical contact, a VH1 electrical contact, and a VH2 electrical contact;

Wherein, the VS electrical contact is a power supply terminal, which is respectively connected to one end of resistor R1 and one end of resistor R3;

The S1 electrical contact is respectively connected to the other end of resistor R1 and one end of resistor R2, and the other end of resistor R2 is grounded;

The S2 electrical contact is respectively connected to the other end of resistor R3 and one end of resistor R4, and the other end of resistor R4 is grounded;

The GND electrical contact is the ground return for the four resistors;

The VH1 electrical contact is connected to the first contact electrode;

The VH2 electrical contact is connected to the second contact electrode.

Optionally, the sensor module may also be provided with a pressing piece (9), the pressing piece (9) is adhered and fixed at the center of the hollow part (21), and the pressing piece (9) is located at the center of each resistor.

A pressure measurement method for a sensor module, wherein when the sensor module is not subjected to pressure, the voltage difference entering the S1 electrical contact and the S2 electrical contact is zero;

When the center of the sensor module is subjected to pressure, due to the deformation of the back surface of the piezoelectric ceramic sheet, the four piezoresistive inks deform;

Among them, the deformation of resistor R1 and resistor R4 is small due to the action of the buffer sheet, and their resistance value changes little;

Resistor R2 and resistor R3 deform greatly by being bent following the deformation of the piezoelectric ceramic sheet, and their resistance value increases;

Thus, the voltage V=voltage VS1−voltage VS2 can be obtained, and the voltage V changes from small to large, wherein voltage VS1 is the voltage at the circuit node between resistor R1 and resistor R2, and voltage VS2 is the voltage at the circuit node between resistor R3 and resistor R4;

Furthermore, within the elastic deformation range of the piezoelectric ceramic sheet, the pressure F exerted on the piezoelectric ceramic sheet is proportional to the voltage V;

By applying multiple preset standard pressures to the piezoelectric ceramic sheet to calibrate the piezoelectric ceramic sheet, the coefficients a and b of the linear equation are calculated using the following linear equation:

F=aV+b;

The coefficients a and b of the equation are obtained, and then the pressure value of the piezoelectric ceramic sheet within the pressure bearing range is deduced.

Compared to related technologies, the beneficial effects of the present disclosure include at least:
1. The sensor module of the present disclosure sets four piezoresistive inks on the FPC board to form resistors, and a piezoelectric ceramic sheet in the gap of the FPC board. The entire module structure is thin, reducing volume.
2. In the pressure measurement method of the sensor module of the present disclosure, when the piezoelectric ceramic sheet is deformed by force, two of the piezoresistive inks deform to increase the resistance value. By calculating the voltage difference, voltage VS1−voltage VS2, and then using F=aV+b, the pressure exerted on the piezoelectric ceramic sheet is measured.
3. The structure of the sensor module of the present disclosure isolates the pressure testing of the pressure sensor from the high-voltage driving of the piezoelectric ceramic sheet, thereby combining the low-voltage part of the pressure sensor and the high-voltage part of the piezoelectric ceramic drive on a single FPC.
4. By increasing the voltage on the drive voltage ports VH1 and VH2 of the piezoelectric ceramic sheet to 100V to 300V, the drive feedback of the piezoelectric ceramic sheet can be achieved.

### BRIEF DESCRIPTION OF THE DRAWINGS

FIG. 1 is an exploded view of the sensor module of the present disclosure.

FIG. 2 is a front structural diagram of the FPC board of the present disclosure.

FIG. 3 is a back structural diagram of the FPC board of the present disclosure.

FIG. 4 is a structural diagram of the circular part of the FPC board adhered to the back of the piezoelectric ceramic sheet of the present disclosure.

FIG. 5 is a circuit diagram of the Wheatstone bridge of the present disclosure.

FIG. 6 is a wiring diagram of the low voltage part of the sensor module and the high voltage part of the piezoelectric ceramic sheet of the present disclosure.

FIG. 7 is a circuit structural diagram of the hollow part of the present disclosure.

FIG. 8 is a perspective view of the visible bottom surface of the sensor module of the present disclosure.

FIG. 9 is a perspective view of the visible front surface of the sensor module of the present disclosure.

FIG. 10 is a structural diagram of the piezoelectric ceramic sheet of the present disclosure.

FIG. 11 is a schematic diagram of the voltage and pressure linearization fitting of the present disclosure.

Markings in the drawings: piezoelectric ceramic sheet 1, FPC board 2, buffer sheet 3, piezoresistive ink 4, low voltage wiring diagram 5, high voltage wiring diagram 6, first conductive double-sided tape 7, second conductive double-sided tape 8, pressing piece 9, ring-shaped copper surface 11, electrode metal contact 12, hollow part 21, circular part 22, first contact electrode 211, second contact electrode 212.

### DETAILED DESCRIPTION OF EMBODIMENTS

The technical solutions in the embodiments of the present disclosure will be clearly and completely described below in conjunction with the accompanying drawings in the embodiments of the present disclosure, so that the advantages and features of the present disclosure can be more easily understood by those skilled in the art, thereby defining the scope of protection of the present disclosure more clearly. Obviously, the embodiments described in the present disclosure are only some embodiments of the present disclosure, and not all embodiments. All other embodiments obtained by ordinary skilled in the art based on the embodiments in the present disclosure without creative labor shall fall within the scope of protection of the present disclosure.

In addition, the technical features involved in the different embodiments of the present disclosure described below can be combined with each other as long as they do not constitute a conflict.

### Embodiment 1

The specific structure of the sensor module for pressure measurement and vibration feedback of the present disclosure is as follows:

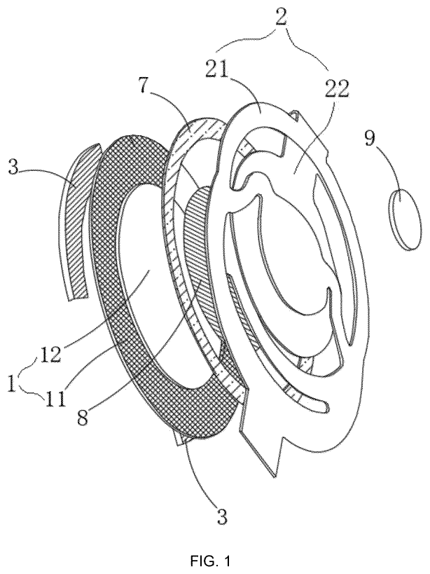

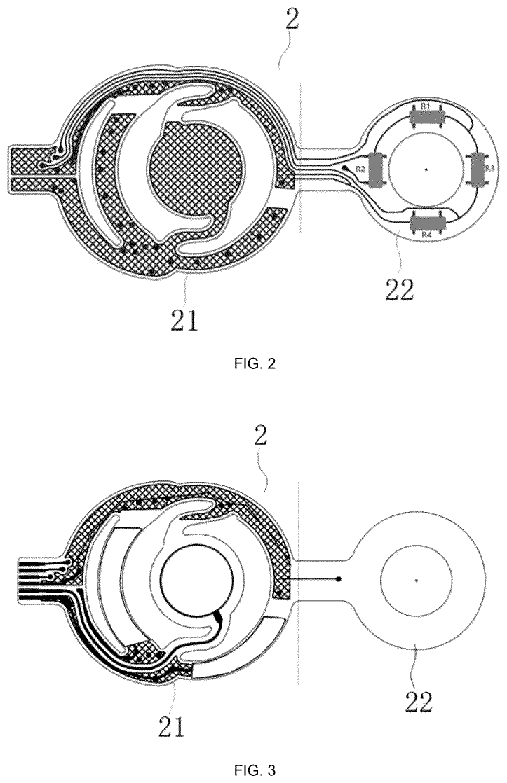

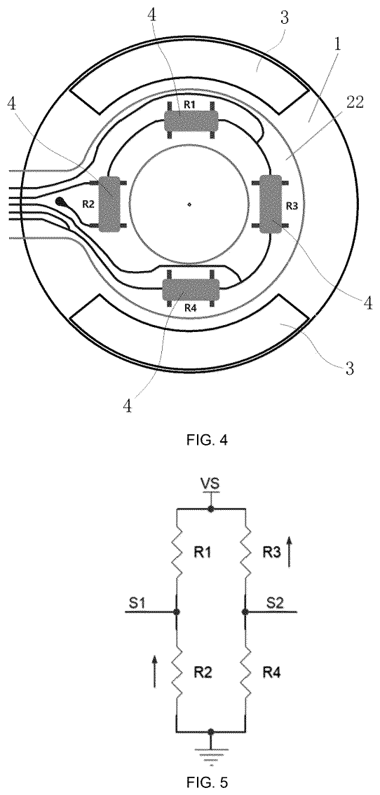

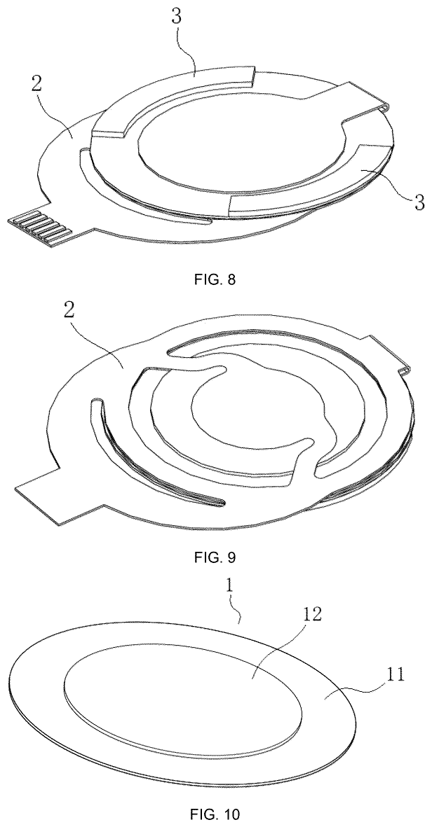

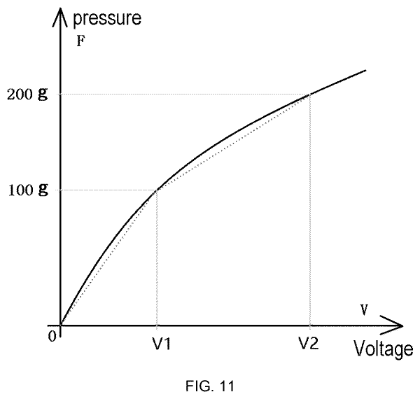

Please refer to FIGS. 1 to 11. The sensor module for pressure measurement and vibration feedback of the present disclosure may include:
A piezoelectric ceramic sheet 1, whose front surface is covered with a ring-shaped copper surface 11 serving as an electrode and an electrode metal contact 12 located in the inner circle of the ring-shaped copper surface 11, wherein the ring-shaped copper surface 11 is adhered with a first conductive double-sided tape 7, and the electrode metal contact 12 is adhered with a second conductive double-sided tape 8;
An FPC board 2, having a connected hollow part 21 and a circular part 22, wherein the hollow part 21 and the circular part 22 form a structure with a gap after being bent at the connection, the piezoelectric ceramic sheet 1 is disposed within this gap, the front surface of the circular part 22 is adhered and fixed to the back surface of the piezoelectric ceramic sheet 1, and the hollow part 21 and the front surface of the piezoelectric ceramic sheet 1 are adhered and fixed by the first conductive double-sided tape 7 and the second conductive double-sided tape 8;
Four piezoresistive inks 4 are printed on the front surface of the circular part 22, these four piezoresistive inks 4 can form resistors and are distributed on the midlines of each side of a rectangle, and these four piezoresistive inks 4 form a Wheatstone bridge circuit;
The hollow part 21, on the side adhered and fixed to the piezoelectric ceramic sheet 1, is provided with a circuit connected to the four piezoresistive inks 4, and this circuit is provided with a first contact electrode 211 and a second contact electrode 212, the first conductive double-sided tape 7 is adhered to the first contact electrode 211 to form an electrically conductive structure, and the second conductive double-sided tape 8 is adhered to the second contact electrode 212 to form an electrically conductive structure;
The back surface of the piezoelectric ceramic sheet 1 is adhered with buffer sheets 3, these multiple buffer sheets 3 are divided into two equal parts, these two parts of buffer sheets 3 are symmetrically disposed at the edge of the piezoelectric ceramic sheet 1 and are respectively close to two opposing piezoresistive inks 4, and far from the other two piezoresistive inks 4.

An optional technical solution of this embodiment: the buffer sheet 3 may be a curved and double-sided adhesive rubber thin sheet or a curved and double-sided adhesive silicone thin sheet.

An optional technical solution of this embodiment: the four piezoresistive inks 4 may be, in clockwise direction, resistor R1, resistor R3, resistor R4, and resistor R2, wherein resistor R1 and resistor R4 are respectively close to the two parts of the buffer sheets 3.

An optional technical solution of this embodiment: one end of the hollow part 21 may be provided with an FPC connector, this FPC connector is provided with six electrical contacts, these six electrical contacts are respectively a VS electrical contact, an S1 electrical contact, an S2 electrical contact, a GND electrical contact, a VH1 electrical contact, and a VH2 electrical contact;

Wherein, the VS electrical contact is a power supply terminal, which is respectively connected to one end of resistor R1 and one end of resistor R3;

The S1 electrical contact is respectively connected to the other end of resistor R1 and one end of resistor R2, and the other end of resistor R2 is grounded;

The S2 electrical contact is respectively connected to the other end of resistor R3 and one end of resistor R4, and the other end of resistor R4 is grounded;

The GND electrical contact is the ground return for the four resistors;

The VH1 electrical contact is connected to the first contact electrode 211;

The VH2 electrical contact is connected to the second contact electrode 212.

### Embodiment 2

A pressure measurement method for a sensor module, wherein when the sensor module is not subjected to pressure, the voltage difference entering the S1 electrical contact and the S2 electrical contact is zero;

When the center of the sensor module is subjected to pressure, due to the deformation of the back surface of the piezoelectric ceramic sheet 1, the four piezoresistive inks 4 deform;

Among them, the deformation of resistor R1 and resistor R4 is small due to the action of the buffer sheet 3, and their resistance value changes little;

Resistor R2 and resistor R3 deform greatly by being bent following the deformation of the piezoelectric ceramic sheet 1, and their resistance value increases;

Thus, the voltage V=voltage VS1−voltage VS2 can be obtained, and the voltage V changes from small to large, wherein voltage VS1 is the voltage at the circuit node between resistor R1 and resistor R2, and voltage VS2 is the voltage at the circuit node between resistor R3 and resistor R4;

Furthermore, within the elastic deformation range of the piezoelectric ceramic sheet 1, the pressure F exerted on the piezoelectric ceramic sheet 1 is proportional to the voltage V;

By applying multiple preset standard pressures to the piezoelectric ceramic sheet 1 to calibrate the piezoelectric ceramic sheet 1, the coefficients a and b of the linear equation are calculated using the following linear equation:

F=aV+b;

The coefficients a and b of the equation are obtained, and then the pressure value of the piezoelectric ceramic sheet 1 within the pressure bearing range is deduced.

### Embodiment 3

The following is the calibration process for the sensor module based on the content of Embodiment 2:

Apply 100 gf and 200 gf to the piezoelectric ceramic sheet 1 for a 2-segment calibration and linear fitting process, and the voltage V can be calculated from voltage VS1−voltage VS2. Therefore:

100=a1V1 (where b1=0) Equation 1

100=a2V1+b2; Equation 2

200=a2V2+b2; Equation 3

Subtracting Equation 2 from Equation 3, we get:

100=a2(V2−V1) Equation 4

Where V1 is the voltage difference measured under a pressure of 100 gf, V1=voltage VS1−voltage VS2. Let V1=2 volts.

V2 is the voltage difference measured under a pressure of 200 gf, V2=voltage VS1−voltage VS2. Let V2=3 volts.

Then, from Equation 1, a1=50 can be calculated. From Equation 4, a2=100 can be calculated. Substituting into Equation 2, we get b2=−100. That is, for pressures from 0 to 100 gf, use F=50V to calculate pressure; for pressures from 100 gf to 200 gf, use F=100V−100 to calculate pressure. If higher precision is required, more intervals can be added.

### Embodiment 4

As shown in FIG. 1, the sensor module of the present disclosure may also be provided with a pressing piece 9, the pressing piece 9 is adhered and fixed at the center of the hollow part 21, and the pressing piece 9 is located at the center of each resistor.

### Embodiment 5

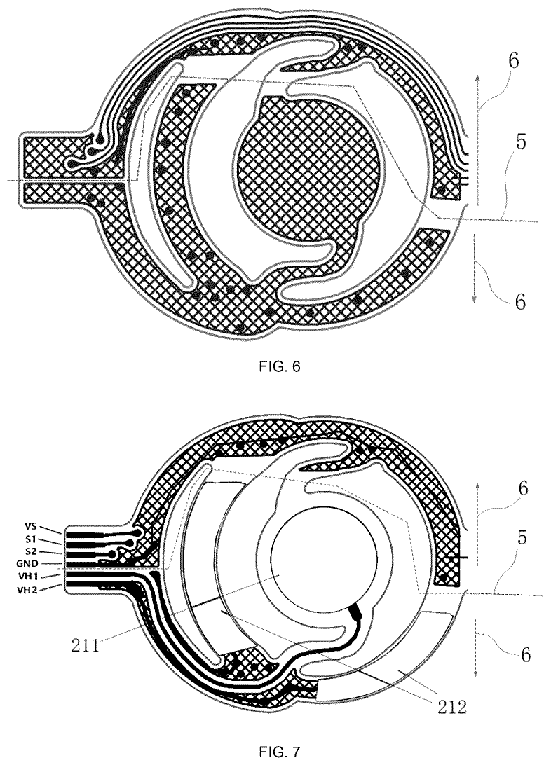

As shown in FIGS. 6-7, FIG. 6 is a wiring diagram of the low voltage part of the sensor module and the high voltage part of the piezoelectric ceramic sheet of the present disclosure. FIG. 7 is a circuit structural diagram of the hollow part of the present disclosure.

In FIG. 6, the dashed lines without arrows represent the low voltage wiring diagram 5 of the sensor module of the present disclosure, and the two dashed lines with arrows are the high voltage wiring diagram 6 for the positive and negative electrodes of the piezoelectric ceramic sheet 1 of the present disclosure. As can be seen from the figure, the pressure testing of the sensor module is isolated from the high-voltage driving of the piezoelectric ceramic sheet, thereby combining the low-voltage part of the sensor module and the high-voltage part of the piezoelectric ceramic drive on a single FPC.

As shown in FIG. 7, by increasing the voltage on the drive voltage ports VH1 and VH2 of the piezoelectric ceramic sheet 1 to 100V to 300V, the drive feedback of the piezoelectric ceramic can be achieved.

In summary, the sensor module of the present disclosure sets four piezoresistive inks on the FPC board to form resistors, and a piezoelectric ceramic sheet in the gap of the FPC board. The entire module structure is thin, reducing volume. In the pressure measurement method of the sensor module of the present disclosure, when the piezoelectric ceramic sheet is deformed by force, two of the piezoresistive inks deform to increase the resistance value. By calculating the voltage difference, voltage VS1−voltage VS2, and then using F=aV+b, the pressure exerted on the piezoelectric ceramic sheet is measured. The structure of the sensor module of the present disclosure isolates the pressure testing of the pressure sensor from the high-voltage driving of the piezoelectric ceramic sheet, thereby combining the low-voltage part of the pressure sensor and the high-voltage part of the piezoelectric ceramic drive on a single FPC. By increasing the voltage on the drive voltage ports VH1 and VH2 of the piezoelectric ceramic sheet to 100V to 300V, the drive feedback of the piezoelectric ceramic sheet can be achieved.

The above are only optional embodiments of the present disclosure, and do not therefore limit the scope of the patent of the present disclosure. Any equivalent structure or equivalent process transformation made by utilizing the description and drawings of the present disclosure, or directly or indirectly applied in other related technical fields, shall likewise be included within the scope of patent protection of the present disclosure.

### Industrial Applicability

The present disclosure provides a sensor module for pressure measurement and vibration feedback and its pressure measurement method. The sensor module includes a piezoelectric ceramic sheet and an FPC board. The sensor module of the present disclosure sets four piezoresistive inks on the FPC board to form resistors, and a piezoelectric ceramic sheet in the gap of the FPC board. The entire module structure is thin, reducing volume. The pressure measurement method of the present disclosure: when the piezoelectric ceramic sheet is deformed by force, two of the piezoresistive inks deform to increase the resistance value. By calculating the voltage difference, voltage VS1−voltage VS2, and then using F=aV+b, the pressure exerted on the piezoelectric ceramic sheet is measured. The structure of the present disclosure isolates the pressure testing of the pressure sensor from the high-voltage driving of the piezoelectric ceramic sheet, thereby combining the low-voltage part of the pressure sensor and the high-voltage part of the piezoelectric ceramic drive on a single FPC. By increasing the voltage on the drive voltage ports VH1 and VH2 of the piezoelectric ceramic sheet to 100V to 300V, the drive feedback of the piezoelectric ceramic sheet can be achieved.

Furthermore, it can be understood that the sensor module for pressure measurement and vibration feedback and its pressure measurement method of the present application are reproducible and can be used in various industrial applications. For example, the sensor module for pressure measurement and vibration feedback and its pressure measurement method of the present application can be used in the field of haptic feedback technology.

What is claimed is

1. A sensor module for pressure measurement and vibration feedback, wherein the sensor module for pressure measurement and vibration feedback comprises:
a piezoelectric ceramic piece, its front surface covered with a ring-shaped copper surface serving as an electrode and an electrode metal contact located within an inner ring of the ring-shaped copper surface, wherein the ring-shaped copper surface is adhered with a first conductive double-sided tape, and the electrode metal contact is adhered with a second conductive double-sided tape;
an FPC board, having a connected hollowed-out part and a circular part, wherein the hollowed-out part and the circular part form a structure with a gap after being bent at a connection point, the piezoelectric ceramic piece is disposed within said gap, a front surface of the circular part is adhered and fixed to a back surface of the piezoelectric ceramic piece, and the hollowed-out part and the front surface of the piezoelectric ceramic piece are adhered and fixed by the first conductive double-sided tape and the second conductive double-sided tape;
four piezoresistive inks printed on the front surface of the circular part, said four piezoresistive inks being capable of forming resistances and distributed on centerlines of each side of a rectangle, said four piezoresistive inks forming a Wheatstone bridge circuit;
the hollowed-out part, on a side adhered and fixed to the piezoelectric ceramic piece, is provided with a circuit connected to the four piezoresistive inks, and in said circuit, a first contact electrode and a second contact electrode are provided, the first conductive double-sided tape is adhered to the first contact electrode to form an electrically conductive structure, and the second conductive double-sided tape is adhered to the second contact electrode to form an electrically conductive structure;
a buffer sheet adhered to the back surface of the piezoelectric ceramic piece, wherein multiple buffer sheets are provided, said multiple buffer sheets are divided into two equal parts, said two parts of buffer sheets are symmetrically arranged at an edge of the piezoelectric ceramic piece and are respectively close to two opposite piezoresistive inks, and far from other two piezoresistive inks.

2. The sensor module for pressure measurement and vibration feedback according to claim 1, wherein the buffer sheet is a curved rubber thin sheet with double-sided adhesive or a curved silicone thin sheet with double-sided adhesive.

3. The sensor module for pressure measurement and vibration feedback according to claim 1, wherein the four piezoresistive inks, in clockwise direction, are resistance R1, resistance R3, resistance R4, and resistance R2, wherein said resistance R1 and said resistance R4 are respectively close to the two parts of the buffer sheet.

4. The sensor module for pressure measurement and vibration feedback according to claim 3, wherein one end of the hollowed-out part is provided with an FPC connector, the FPC connector is provided with six electrical contacts, said six electrical contacts are a VS electrical contact, an SI electrical contact, an S2 electrical contact, a GND electrical contact, a VH1 electrical contact, and a VH2 electrical contact;
wherein, the VS electrical contact is a power supply terminal, which is respectively connected to one end of said resistance R1 and one end of said resistance R3;
the S1 electrical contact is respectively connected to another end of said resistance R1 and one end of said resistance R2, and another end of said resistance R2 is grounded;
the S2 electrical contact is respectively connected to another end of said resistance R3 and one end of said resistance R4, and another end of said resistance R4 is grounded;
the GND electrical contact is a ground return for the four resistances;
the VH1 electrical contact is connected to the first contact electrode;
the VH2 electrical contact is connected to the second contact electrode.

5. The sensor module for pressure measurement and vibration feedback according to claim 1, wherein the sensor module further comprises a pressing piece, the pressing piece is adhered and fixed at a center of the hollowed-out part, and the pressing piece is located at a center of each resistance.

6. A method for pressure measurement of a sensor module, wherein the method for pressure measurement of a sensor module comprises using the sensor module according to claim 1.

7. The method for pressure measurement according to claim 6, wherein when the sensor module is not subjected to pressure, a voltage difference entering the S1 electrical contact and the S2 electrical contact is zero;
when a center of the sensor module is subjected to pressure, due to deformation of the back surface of the piezoelectric ceramic piece, the four piezoresistive inks deform;
wherein, deformation of said resistance R1 and said resistance R4 is small due to action of the buffer sheet, and their resistance value change is small;
said resistance R2 and said resistance R3 are bent and deform greatly following deformation of the piezoelectric ceramic piece, and their resistance values increase;
thus, a voltage V=voltage VS1−voltage VS2 is obtained, and voltage V changes from small to large, wherein voltage VS1 is a voltage entering a circuit node between said resistance R1 and said resistance R2, and said voltage VS2 is a voltage entering a circuit node between said resistance R3 and said resistance R4;
furthermore, within an elastic deformation range of the piezoelectric ceramic piece, a pressure F exerted on the piezoelectric ceramic piece is directly proportional to the voltage V;
by applying multiple preset standard pressures on the piezoelectric ceramic piece to calibrate the piezoelectric ceramic piece, coefficients a and b of a linear equation F=aV+b are calculated;
the coefficients a and b of said equation are obtained, and then a pressure value of the piezoelectric ceramic piece within its pressure bearing range is inferred.
